(19) United States
(12) Patent Application Publication
(10) Pub. No.: US 2026/0011037 A1
(43) Pub. Date: Jan. 8, 2026

(54) STREAMING METHOD AND SYSTEM FOR PROVIDING REALITY CONTENT AND COMPUTER-READABLE STORAGE MEDIUM

(71) Applicant: HTC Corporation, Taoyuan City (TW)

(72) Inventors: Joseph Chengwei Tsai, Taoyuan City (TW); Jiun-Lin Chen, Taoyuan City (TW)

(73) Assignee: HTC Corporation, Taoyuan City (TW)

(21) Appl. No.: 18/915,222

(22) Filed: Oct. 14, 2024

Related U.S. Application Data
(60) Provisional application No. 63/668,319, filed on Jul. 8, 2024.

(51) Int. Cl. G06T 9/00; G06T 19/00

(52) U.S. Cl. CPC G06T 9/001; G06T 19/006

(57) ABSTRACT

A streaming method and system for providing reality content and a computer-readable storage medium are provided. The method includes: obtaining first visual content of a reality service and identifying a first-type object and a second-type object from the first visual content, where the first-type object is selected to satisfy a first visual quality requirement; obtaining object information of the first-type object and sending the object information of the first-type object to a client device; and compressing the second-type object and sending the compressed second-type object to the client device, where the object information of the first-type object and the compressed second-type object are used by the client device to accordingly generate second visual content.

### CROSS-REFERENCE TO RELATED APPLICATION

This application claims the priority benefit of U.S. provisional application Ser. No. 63/668,319, filed on Jul. 8, 2024. The entirety of the above-mentioned patent application is hereby incorporated by reference herein and made a part of this specification.

### BACKGROUND

### Technical Field

The disclosure relates to a streaming technology, and in particular, relates to a streaming method and system for providing reality content and a computer-readable storage medium.

### Description of Related Art

When a local texture or video is to be transmitted to a remote device, in many solutions, video encoding is chosen and used to compress the stream for streaming. However, lossless compression is not feasible for transmitting the encoded buffered data over the network. Therefore, lossy compression becomes the only viable method.

In this case, ensuring that visual quality remains high becomes a key consideration. To enhance visual quality, there are several methods to choose from, such as the Foveal compression technology which focuses on enhancing specific areas frame by frame. However, in scenes containing specific objects, users may still experience a degradation in the visual quality of those objects.

### SUMMARY

Accordingly, the disclosure provides a streaming method and system for providing reality content and a computer-readable storage medium capable of solving the above technical problems.

An embodiment of the disclosure provides a streaming method for providing reality content, and the method includes the following steps. A server obtains first visual content of a reality service and identifies a first-type object and a second-type object from the first visual content. The first-type object is selected to satisfy a first visual quality requirement. The server obtains object information of the first-type object and sends the object information of the first-type object to a client device. The server compresses the second-type object and sends the compressed second-type object to the client device. The object information of the first-type object and the compressed second-type object are used by the client device to accordingly generate second visual content.

An embodiment of the disclosure further provides a streaming system for providing reality content. The system includes a server, and the server is configured to obtain first visual content of a reality service and identify a first-type object and a second-type object from the first visual content, where the first-type object is selected to satisfy a first visual quality requirement, obtain object information of the first-type object and send the object information of the first-type object to a client device, and compress the second-type object and send the compressed second-type object to the client device, where the object information of the first-type object and the compressed second-type object are used by the client device to accordingly generate second visual content.

An embodiment of the disclosure further provides a non-transitory computer-readable storage medium recording an executable computer program loaded by a streaming system for providing reality content to execute the following steps. First visual content of a reality service is obtained, and a first-type object and a second-type object are identified from the first visual content. The first-type object is selected to satisfy a first visual quality requirement. Object information of the first-type object is obtained, and the object information of the first-type object is sent to a client device. The second-type object is compressed, and the compressed second-type object is sent to the client device. The object information of the first-type object and the compressed second-type object are used by the client device to accordingly generate second visual content.

To make the aforementioned more comprehensible, several embodiments accompanied with drawings are described in detail as follows.

### BRIEF DESCRIPTION OF THE DRAWINGS

The accompanying drawings are included to provide a further understanding of the

disclosure, and are incorporated in and constitute a part of this specification. The drawings illustrate exemplary embodiments of the disclosure and, together with the description, serve to explain the principles of the disclosure.

FIG. 1 is a schematic view illustrating a streaming system for providing reality content according to an embodiment of the disclosure.

FIG. 2 is a schematic view illustrating a streaming method for providing reality content according to an embodiment of the disclosure.

FIG. 3 shows an application scenario according to an embodiment of the disclosure.

### DESCRIPTION OF THE EMBODIMENTS

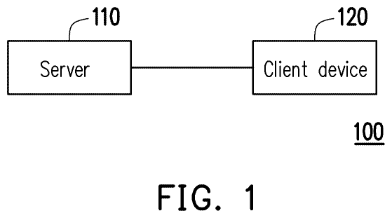

See FIG. 1, which is a schematic view illustrating a streaming system for providing reality content according to an embodiment of the disclosure. In FIG. 1, a system 100 may include a server 110 and a client device 120, and the server 110 and the client device 120 may be connected to each other via various wired or wireless connection methods (e.g., a wireless network). In different embodiments, the server 110 and/or the client device 120 may be implemented as various smart devices and/or computer devices, but the disclosure is not limited thereto.

In an embodiment, the server 110 may provide specific visual content to the client device 120 in a streaming manner, so that the client device 120 can restore the visual content for its user to watch.

In an embodiment, the client device 120 is, for example, a wearable device that can be used to provide various reality services (such as virtual reality (VR), augmented reality (AR), mixed reality (MR), and extended reality (XR)), such as a head-mounted display (HMD), but the disclosure is not limited thereto. In this case, the server 110 may provide visual content related to the reality service (e.g., VR/AR/MR/XR content) to the client device 120 in a streaming manner, but the disclosure is not limited thereto.

However, as mentioned in the above, existing streaming technologies may not allow specific objects in specific scenes to be presented to users in a manner with high visual quality, which may affect the users' viewing experience.

For instance, it is assumed that the reality service provided by the client device 120 allows a user to immerse in a virtual environment corresponding to a specific field (such as an art gallery/museum), and specific objects (such as various artworks) for viewing are exhibited in the specific field. However, when the server 110 provides the visual content related to the reality service to the client device 120 in a streaming manner in the conventional way, the server 100 may firstly compress the entire visual content (including the abovementioned specific objects) and sends it to the client device 120, and then the client device 120 restores the visual content accordingly. In this process, since the specific objects are also compressed, the specific objects cannot be presented to the user with satisfying visual quality in the visual content restored by the client device 120.

In view of the above, the disclosure provides a streaming method for providing reality content capable of solving the above technical problems. Detailed discussions would be provided in the following.

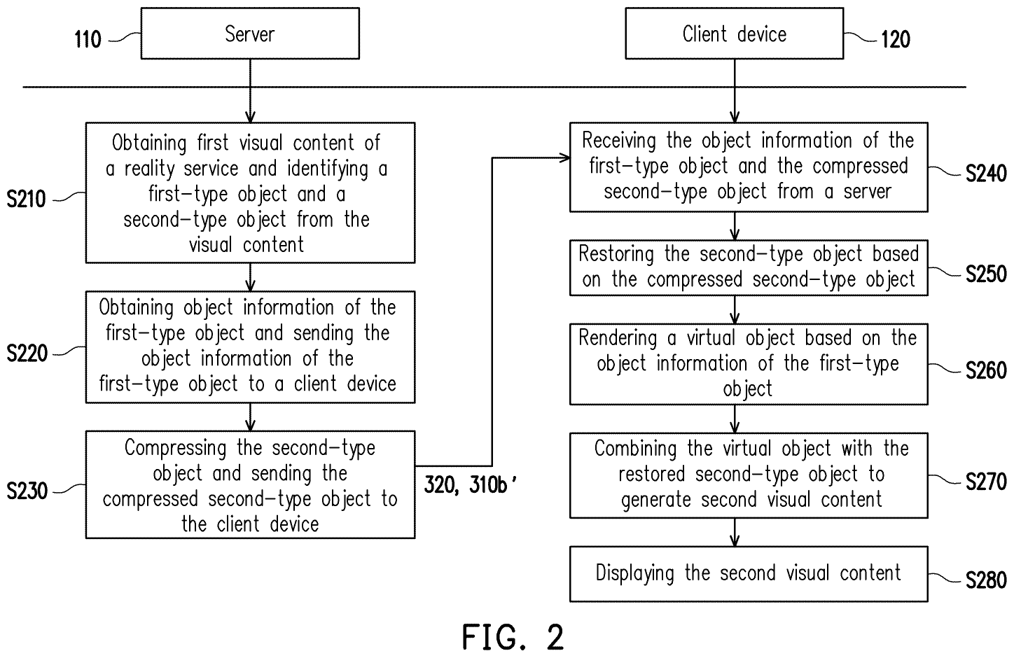

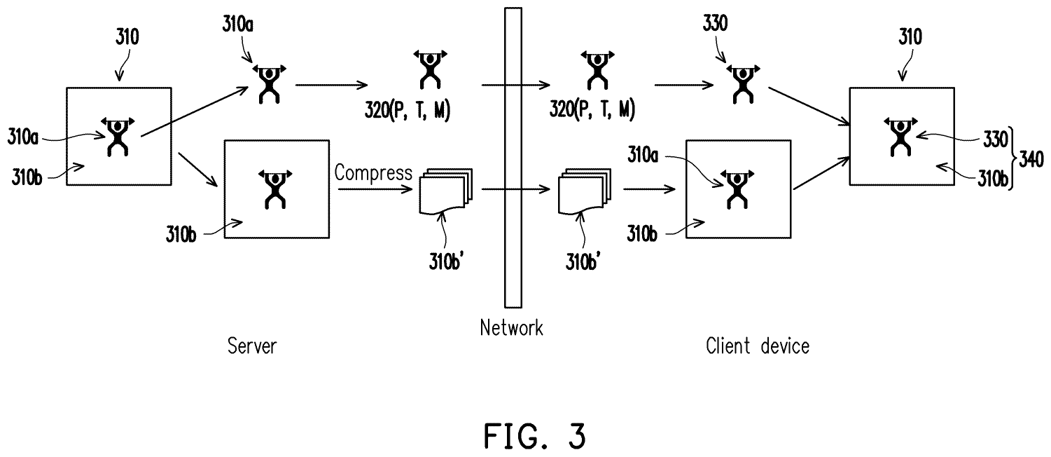

See FIG. 2, which is a schematic view illustrating a streaming method for providing reality content according to an embodiment of the disclosure. The method provided by this embodiment may be executed by the system 100 in FIG. 1, and each step in FIG. 2 is described in detail together with the devices shown in FIG. 1. Further, in order to make the concepts of the disclosure easier to understand, FIG. 3 would be used as an example for explanation, wherein FIG. 3 shows an application scenario according to an embodiment of the disclosure.

Firstly, in step S210, the server 110 obtains first visual content 310 of a reality service and identifies a first-type object 310a and a second-type object 310b from the first visual content 310. In the embodiments of the disclosure, the first-type object 310a may be selected to satisfy a first visual quality requirement.

Continuing with the examples used in the foregoing paragraphs, the first-type object 310a is, for example, a specific object mentioned in the foregoing paragraphs for viewing (such as an artwork), or an object that needs to be presented with higher visual quality, but the disclosure is not limited thereto.

In an embodiment, during the development of the reality service (e.g., VR/AR/MR/XR service, etc.), a developer can select objects that need to meet the first visual quality requirement from a virtual scene and/or a virtual environment of the reality service through specific interfaces/programmed means, and these objects may be classified as the first-type object 310a, but the disclosure is not limited thereto.

In an embodiment, the second-type object 310b may include, for example, the entire virtual scene and/or the virtual environment. In an embodiment, the second-type object 310b may be an object that needs to be compressed and transmitted to the client device 120 in the related art.

In an embodiment, the second-type object 310b may also be an object in the virtual scene and/or the virtual environment that is not selected to satisfy the first visual quality requirement.

In addition, in other embodiments, during the development of the reality service, the developer can also select objects that need to meet a second visual quality requirement from the virtual scene and/or the virtual environment of the reality service through specific interfaces/programmed means, and the first visual quality requirement is higher than the second visual quality requirement.

In some embodiments, the second-type object 310b may be an object that is allowed to be presented with lower visual quality, but the disclosure is not limited thereto.

In the scenario of FIG. 3, the first-type object 310a is, for example, a virtual object corresponding to a portrait artwork, and the second-type object 310b may be a virtual scene (whose display range includes the first-type object 310a) currently displayed by the first visual content 310. In this embodiment, the second-type object 310b may also be understood to include a virtual scene object in the first visual content 310.

In step S220, the server 110 obtains object information 320 of the first-type object 310a and sends the object information 320 of the first-type object 310a to the client device 120.

In different embodiments, the object information 320 of the first-type object 310a includes at least one of a pose P, a texture T, and a mesh M of the first-type object 310a.

In different embodiments, the pose P may include, for example, translation and/or rotation components of the first-type object 310a and may be represented in a conventional six-degree-of-freedom (6DOF) format. The mesh M may be used to, for example, represent a polygonal structure of a shape of the first-type object 310a (e.g., a three-dimensional object). Generally, the mesh M is composed of a series of vertices, edges, and faces, where the faces are usually triangles or quadrilaterals, and these polygons together constitute the surface shape of the first-type object 310a and determine an appearance of the first-type object 310a in the virtual environment.

The texture T may be used to represent appearance details of the first-type object 310a, such as color, pattern, material (such as wood grain, metal texture, or stone surface), etc., so as to make the first-type object 310a look real and concrete.

In some embodiments, the pose P, texture T, and mesh M of the first-type object 310a are raw data, that is, uncompressed data, but the disclosure is not limited thereto.

In an embodiment, in response to determining that the first-type object 310a enters a field of view (FOV) provided by the client device 120 for the first time, the server 110 may read and store the object information 320 of the first-type object 310a.

In the embodiment of the disclosure, the field of view is, for example, a visual range that a user can see when immersed in the reality service. In an embodiment, when a user wearing the client device 120 (e.g., HMD) is immersed in the virtual environment corresponding to the specific field, the user may move around to view various objects placed in the virtual environment, and this behavior may be understood as these objects entering the user's field of view (i.e., the field of view provided by the client device 120).

In this case, the above means may be understood as when the first-type object 310a enters the user's visual range for the first time when the user is immersed in the reality service, the server 110 may read and store the object information 320 of the first-type object 310a, but the disclosure is not limited thereto.

In an embodiment, the server 110 may read the object information 320 of the first-type object 310a from a remote database associated with the reality service and store the object information 320 of the first-type object 310a in a local database of the server 110, but the disclosure is not limited thereto.

In an embodiment, in response to determining that the first-type object 310a re-enters the field of view provided by the client device 120 after leaving the field of view provided by the client device 120, the server 110 may obtain the stored object information 320 of the first-type object 310a. For instance, the server 110 may read the previously stored object information 320 of the first-type object 310a from the local database of the server 110, but the disclosure is not limited thereto.

From another perspective, the server 110 may only need to read the object information 320 from the remote database once. Thereafter, even if the first-type object 310a repeatedly enters and leaves the field of view provided by the client device 120, the server 110 only needs (from the local database) to obtain the previously stored object information 320 and does not need to read the object information 320 from the remote database again, but the disclosure is not limited thereto.

In step S230, the server 110 compresses the second-type object 310b and sends the compressed second-type object 310b to the client device 120. The object information 320 of the first-type object 310a and the compressed second-type object 310b are used by the client device 120 to accordingly generate second visual content 340.

For ease of understanding, the compressed second-type object 310b is represented as a second-type object 310b′ in FIG. 3, but the disclosure is not limited thereto.

In different embodiments, the server 110 may generate the second-type object 310b′ based on a general compression algorithm and/or various encoding algorithms (e.g., H.264, H.265, etc.), but the disclosure is not limited thereto.

In the scenario of FIG. 3, since the second-type object 310b is assumed to be the virtual scene currently displayed by the first visual content 310 (whose display range includes the first-type object 310a), the second-type object 310b′ may be understood as including the compressed first-type object 310a, but the disclosure is not limited thereto.

In step S240, the client device 120 receives the object information 320 of the first-type object 310a and the compressed the second-type object 310b (i.e., the second-type object 310b′) from the server 110.

In the scenario of FIG. 3, the client device 120 may receive the object information 320 and the second-type object 310b′ via a network, for example, but the disclosure is not limited thereto.

In step S250, the client device 120 restores the second-type object 310b based on the compressed second-type object 310b (i.e., the second-type object 310b′). In some embodiments, the client device 120 may restore the second-type object 310b′ to the second-type object 310b based on existing technologies/algorithms for restoring compressed information.

In an embodiment, the second-type object 310b may include one or more image frames (e.g., left eye image frame and/or right eye image frame) corresponding to the user's eyes (e.g., left eye and/or right eye). In this case, the server 110 may, for example, compress the second-type object 310b into the second-type object 310b′ based on existing image compression/encoding technology and send the second-type object 310b′ to the client device 120. After that, the client device 120 can use corresponding image decompression/decoding technology in response to the image compression/encoding technology used by the server 110 to restore the second-type object 310b′ to the second-type object 310b, but the disclosure is not limited thereto.

In addition, in the scenario of FIG. 3, since the second-type object 310b′ may be understood as including the compressed first-type object 310a, the second-type object 310b restored by the client device 120 may include the first-type object 310a, but its visual quality is lower due to the compression and restoration process.

In step S260, the client device 120 renders a virtual object 330 based on the object information 320 of the first-type object 310a, where the rendered virtual object 330 satisfies the first visual quality requirement.

In the scenario of FIG. 3, since the object information 320 may include the texture T, the pose P, and the mesh M (which is, for example, uncompressed raw data) of the first-type object 310a, the virtual object 330 with improved visual quality may be rendered by the client device 120.

In this embodiment, the virtual object 330 is, for example, the object (e.g., the portrait artwork object that is shown) corresponding to the first-type object 310a restored by the client device 120 according to the object information 320. Further, in this embodiment, the visual quality of the virtual object 330 may be better than the visual quality of the first-type object 310a in the second-type object 310b restored by the client device 120.

In step S270, the client device 120 combines the virtual object 330 with the restored second-type object 310b to generate the second visual content 340.

In FIG. 3, the client device 120 may overlay the virtual object 330 on the restored second- type object 310b, and an overlay position of the virtual object 330 on the restored second-type object 310b may correspond to a position of the first-type object 310a in the restored second-type object 310b.

In an embodiment, the client device 120 may project the virtual object 330 onto the corresponding left eye image frame and/or right eye image frame based on the pose P, the eye pose of the user's eyes (e.g., left eye and/or right eye), and the device pose of the client device 120. In this way, the projected virtual object 330 may be superimposed on the position of the first-type object 310a in the restored second-type object 310b, but the disclosure is not limited thereto

In step S280, the client device 120 displays the second visual content 340. In an embodiment where the client device 120 is assumed to be an HMD, the client device 120 may display the second visual content 340 to the user's corresponding eyes through a near-eye display corresponding to the user's eyes, but the disclosure is not limited thereto.

In FIG. 3, since the second visual content 340 (which may be understood as the restored first visual content 310) includes the virtual object 330 with improved visual quality, the user may obtain an improved visual experience when viewing the second visual content 340 (the virtual object 330), but the disclosure is not limited thereto.

The disclosure further provides a computer-readable storage medium for executing a streaming method for providing reality content. The computer-readable storage medium is composed of a plurality of program commands (e.g., configuration program commands and deployment program commands) embodied therein. These program commands may be loaded into and executed by the server 110 and/or the client device 120 of the system 100 to perform the functions of the streaming method and system 100 for providing reality content.

In view of the foregoing, in the method provided by the embodiments of the disclosure, when the server sends the compressed second-type object to the client device, the object information (e.g., texture, pose, mesh, etc.) of the first-type object selected to satisfy higher visual quality requirement may be additionally sent to the client device. In this way, a virtual object with improved visual quality may be rendered by the client device, and the client device may then combine the virtual object with the restored second-type object to generate the restored visual content. In this case, since the virtual object may be presented with improved visual quality in the restored visual content, an improved visual experience may be provided to the user.

It will be apparent to those skilled in the art that various modifications and variations can be made to the disclosed embodiments without departing from the scope or spirit of the disclosure.

In view of the foregoing, it is intended that the disclosure covers modifications and variations provided that they fall within the scope of the following claims and their equivalents.

What is claimed is:

1. A streaming method for providing reality content, comprising:
obtaining, by a server, first visual content of a reality service and identifying, by the server, a first-type object and a second-type object from the first visual content, wherein the first-type object is selected to satisfy a first visual quality requirement;
obtaining, by the server, object information of the first-type object and sending the object information of the first-type object to a client device; and
compressing, by the server, the second-type object and sending, by the server, the compressed second-type object to the client device, wherein the object information of the first-type object and the compressed second-type object are used by the client device to accordingly generate second visual content.

2. The method according to claim 1, wherein the second-type object is not selected to satisfy the first visual quality requirement.

3. The method according to claim 1, wherein the second-type object is selected to satisfy a second visual quality requirement, wherein the first visual quality requirement is higher than the second visual quality requirement.

4. The method according to claim 1, wherein the object information of the first-type object comprises at least one of a pose, a texture, and a mesh of the first-type object.

5. The method according to claim 4, wherein the pose, the texture, and the mesh of the first-type object are raw data.

6. The method according to claim 1, wherein the second-type object comprises a virtual scene object of the first visual content.

7. The method according to claim 1, wherein the obtaining the object information of the first-type object comprises:
in response to determining that the first-type object enters a field of view provided by the client device for the first time, reading and storing the object information of the first-type object.

8. The method according to claim 7, further comprising:
in response to determining that the first-type object re-enters the field of view provided by the client device after leaving the field of view provided by the client device, obtaining, by the server, the stored object information of the first-type object.

9. The method according to claim 7, wherein the reading and storing the object information of the first-type object comprises:
reading, by the server, the object information of the first-type object from a remote database associated with the reality service; and
storing, by the server, the object information of the first-type object in a local database of the server.

10. The method according to claim 1, further comprising:
receiving, by the client device, the object information of the first-type object and the compressed second-type object from the server;
restoring, by the client device, the second-type object based on the compressed second-type object;
rendering, by the client device, a virtual object based on the object information of the first-type object, wherein the rendered virtual object satisfies the first visual quality requirement;
combining, by the client device, the virtual object with the restored second-type object to generate the second visual content; and
displaying, by the client device, the second visual content.

11. A streaming system for providing reality content, comprising:
a server configured to:
obtain first visual content of a reality service and identify a first-type object and a second-type object from the first visual content, wherein the first-type object is selected to satisfy a first visual quality requirement;
obtain object information of the first-type object and send the object information of the first-type object to a client device; and
compress the second-type object and send the compressed second-type object to the client device, wherein the object information of the first-type object and the compressed second- type object are used by the client device to accordingly generate second visual content.

12. The system according to claim 11, wherein the second-type object is not selected to satisfy the first visual quality requirement or is selected to satisfy a second visual quality requirement, wherein the first visual quality requirement is higher than the second visual quality requirement.

13. The system according to claim 11, wherein the object information of the first-type object comprises at least one of a pose, a texture, and a mesh of the first-type object.

14. The system according to claim 13, wherein the pose, the texture, and the mesh of the first-type object are raw data.

15. The system according to claim 11, wherein the second-type object comprises a virtual scene object of the first visual content.

16. The system according to claim 11, wherein the server is configured to:
in response to determining that the first-type object enters a field of view provided by the client device for the first time, read and store the object information of the first-type object.

17. The system according to claim 16, wherein the server is further configured to:
in response to determining that the first-type object re-enters the field of view provided by the client device after leaving the field of view provided by the client device, obtain the stored object information of the first-type object.

18. The system according to claim 16, wherein the server is configured to:
read the object information of the first-type object from a remote database associated with the reality service; and
store the object information of the first-type object in a local database of the server.

19. The system according to claim 11, wherein the system further comprises the client device, and the client device is configured to:
receive the object information of the first-type object and the compressed second-type object from the server;
restore the second-type object based on the compressed second-type object;
render a virtual object based on the object information of the first-type object, wherein the rendered virtual object satisfies the first visual quality requirement;
combine the virtual object with the restored second-type object to generate the second visual content; and
display the second visual content.

20. A non-transitory computer-readable storage medium recording an executable computer program loaded by a streaming system for providing reality content to execute the steps of:
obtaining first visual content of a reality service and identifying a first-type object and a second-type object from the first visual content, wherein the first-type object is selected to satisfy a first visual quality requirement;
obtaining object information of the first-type object and sending the object information of the first-type object to a client device; and
compressing the second-type object and sending the compressed second-type object to the client device, wherein the object information of the first-type object and the compressed second- type object are used by the client device to accordingly generate second visual content.
